(19) United States
(12) Patent Application Publication
(10) Pub. No.: US 2017/0288393 A1
(43) Pub. Date: Oct. 5, 2017

(54) INPUT OVERVOLTAGE PROTECTION CIRCUIT

(71) Applicant: FANUC CORPORATION, Yamanashi (JP)

(72) Inventors: Shuuji Kudou, Minamitsuru-gun (JP); Yoshinori Sakai, Minamitsuru-gun (JP)

(73) Assignee: FANUC CORPORATION, Yamanashi (JP)

(21) Appl. No.: 15/477,391

(22) Filed: Apr. 3, 2017

(30) Foreign Application Priority Data
Apr. 5, 2016 (JP) 2016-076030

(51) Int. Cl. H02H 3/20; H02H 9/04

(52) U.S. Cl. CPC H02H 3/20; H02H 9/044

(57) ABSTRACT

An input overvoltage protection circuit is equipped with a first wiring and a second wiring which are connected to a protected circuit in order to supply a voltage thereto, a fuse inserted in series in the first wiring and which interrupts a current flowing through the first wiring when a current greater than or equal to a predetermined value flows therethrough, a silicon surge absorber, one end of which is connected between the protected circuit and the fuse in the first wiring, and the other end of which is connected to the second wiring, and a bidirectional two-terminal thyristor connected to the first wiring and to the second wiring at a location between the silicon surge absorber and the protected circuit.

### CROSS-REFERENCE TO RELATED APPLICATION

This application is based upon and claims the benefit of priority from Japanese Patent Application No. 2016-076030 filed on Apr. 5, 2016, the contents of which are incorporated herein by reference.

### BACKGROUND OF THE INVENTION

### Field of the Invention

The present invention relates to an input overvoltage protection circuit for protecting a protected circuit from overvoltages.

### Description of the Related Art

In Japanese Laid-Open Patent Publication No. 07-184319, there is disclosed a protection circuit for protecting a protected circuit using a fuse and a breakover type semiconductor surge absorber (See FIG. 1 of Japanese Laid-Open Patent Publication No. 07-184319).

Japanese Laid-Open Patent Publication No. 09-215176 discloses a protection device for protecting against overvoltage inputs in which there is no need for replacement of components or repairs. To provide a simple description thereof, the protection device includes a bidirectional thyristor and a switching element for electrically connecting or interrupting the connection between an external power supply and equipment, an overvoltage detecting unit that disconnects the bidirectional thyristor in the case that a voltage of the external power supply is a steady overvoltage, and a transient voltage detecting unit that disconnects the switching element in the case that the voltage of the external power supply is a momentary overvoltage.

### SUMMARY OF THE INVENTION

A breakover type semiconductor surge absorber has a characteristic of becoming conductive when a voltage greater than or equal to a breakover voltage is applied thereto. Consequently, in the case of a protection circuit in which a fuse and a breakover type semiconductor surge absorber are used, as in the aforementioned Japanese Laid-Open Patent Publication No. 07-184319, when a low energy overvoltage (an excessive voltage higher than the breakover voltage) is momentarily generated, the breakover type semiconductor surge absorber becomes conductive, and the fuse is blown. Further, since momentary overvoltages (surges) of this type occur frequently due to the influence of other circuit operations and the like, it becomes necessary to replace the fuse with each occurrence, thus consuming time and effort as well as costs to deal with such occurrences.

On the other hand, as one type of surge absorber, a silicon surge absorber is known. Such a silicon surge absorber absorbs voltages even if a voltage greater than or equal to a clamp voltage (clamping voltage) is applied thereto, and suppresses a voltage applied to another subsequent stage circuit so as to remain at the clamp voltage. Consequently, by replacing the breakover type semiconductor surge absorber shown in FIG. 1 of Japanese Laid-Open Patent Publication No. 07-184319 with a silicon surge absorber, it is possible to prevent the fuse from blowing due to momentary generation of a low energy overvoltage. However, energy absorbed by the silicon surge absorber leads to heat being generated within the element of the silicon surge absorber. Although the temperature of the element of the silicon surge absorber does not rise very much even if a low energy overvoltage occurs momentarily, when a high energy overvoltage is generated, the temperature of the element of the silicon surge absorber tends to rise easily. When the temperature inside the element exceeds a certain limit, the silicon surge absorber becomes damaged and short circuited, which in turn causes the fuse to blow. Further, if the silicon surge absorber becomes damaged, not only the fuse but also the silicon surge absorber itself must be replaced, which leads to high costs.

Further, in the protection device for protecting against overvoltage inputs of the aforementioned Japanese Laid-Open Patent Publication No. 09-215176, since various components are required such as the bidirectional thyristor, the switching element, the overvoltage detecting unit, and the transient voltage detecting unit, costs are increased together with an increase in the size of the installation area, and further, the protection device becomes larger in scale.

Thus, an object of the present invention is to provide an input overvoltage protection circuit which, while suppressing costs and having a simple configuration, protects a protected circuit from overvoltages.

A first invention is characterized by an input overvoltage protection circuit, including a first wiring and a second wiring which are connected to a protected circuit in order to supply a voltage thereto, a fuse inserted in series in the first wiring and configured to interrupt a current flowing through the first wiring when a current greater than or equal to a predetermined value flows therethrough, a first surge absorber, one end of which is connected between the protected circuit and the fuse in the first wiring, and the other end of which is connected to the second wiring, and which is configured to suppress an applied voltage to a first voltage and output the first voltage in the case that the applied voltage is higher than the first voltage, and a second surge absorber connected in parallel with the first surge absorber, and connected to the first wiring and to the second wiring at a location between the first surge absorber and the protected circuit, and which is configured to become conductive when a voltage greater than a second voltage is applied thereto.

Owing thereto, while suppressing costs and having a simple configuration, it is possible to protect the protected circuit from overvoltages. More specifically, if a low energy overvoltage is momentarily generated, without blowing the fuse, the protected circuit can still be protected from the low energy overvoltage by the first surge absorber. Further, in the event that a high energy overvoltage is applied, the fuse is blown and the protected circuit can be protected from the high energy overvoltage by the second surge absorber, and together therewith, it is possible to prevent the first surge absorber from becoming damaged.

In the input overvoltage protection circuit of the first invention, the first voltage increases accompanying a rise in a temperature of an element of the first surge absorber, and the second voltage is set to be higher than the first voltage before the temperature of the element rises, and is set to be lower than the first voltage corresponding to a maximum temperature of the element at which the first surge absorber is damaged and becomes conductive.

In accordance with this feature, even in the event that a high energy overvoltage is applied, prior to the first surge absorber becoming damaged, since the second surge absorber becomes conductive and the fuse is blown, it is possible to prevent the first surge absorber from becoming damaged, and costs can be reduced.

In the input overvoltage protection circuit of the first invention, a potential which is higher than a potential applied to the second wiring is applied to the first wiring.

A second invention is characterized by an input overvoltage protection circuit, including a first wiring and a second wiring which are connected to a protected circuit in order to supply a voltage thereto, a fuse inserted in series in the first wiring and configured to interrupt a current flowing through the first wiring when a current greater than or equal to a predetermined value flows therethrough, a silicon surge absorber, one end of which is connected between the protected circuit and the fuse in the first wiring, and another end of which is connected to the second wiring, and a bidirectional two-terminal thyristor connected in parallel with the silicon surge absorber, and connected to the first wiring and to the second wiring at a location between the silicon surge absorber and the protected circuit.

Owing thereto, while suppressing costs and having a simple configuration, it is possible to protect the protected circuit from overvoltages. More specifically, if a low energy overvoltage is momentarily generated, without blowing the fuse, the protected circuit can still be protected from the low energy overvoltage by the silicon surge absorber. Further, in the event that a high energy overvoltage is applied, the fuse is blown and the protected circuit can be protected from the high energy overvoltage by the bidirectional two-terminal thyristor, and together therewith, it is possible to prevent the silicon surge absorber from becoming damaged.

In the input overvoltage protection circuit of the second invention, a clamp voltage of the silicon surge absorber increases accompanying a rise in a junction temperature of the silicon surge absorber, and a breakover voltage of the bidirectional two-terminal thyristor is set to be higher than the clamp voltage before the junction temperature rises, and to be lower than the clamp voltage corresponding to a maximum temperature of the junction temperature.

In accordance with this feature, even in the event that a high energy overvoltage is applied, prior to the silicon surge absorber becoming damaged, since the bidirectional two-terminal thyristor becomes conductive and the fuse is blown, it is possible to prevent the silicon surge absorber from becoming damaged, and costs can be reduced.

According to the present invention, while suppressing costs and having a simple configuration, it is possible to protect the protected circuit from overvoltages. More specifically, if a low energy overvoltage is momentarily generated, without blowing the fuse, the protected circuit can still be protected from the low energy overvoltage. Further, in the event that a high energy overvoltage is applied, the fuse is blown and the protected circuit can be protected from the high energy overvoltage, and together therewith, it is possible to prevent the surge absorber from becoming damaged.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram showing the circuit configuration of an input overvoltage protection circuit according to an embodiment of the present invention;

FIG. 2A is a graph showing an input voltage waveform including therein momentarily generated low energy overvoltages;

FIG. 2B is a graph showing an output voltage waveform of a silicon surge absorber for a case in which the input voltage shown in FIG. 2A is input thereto; and

FIG. 3 is a graph showing an output voltage waveform of a silicon surge absorber for a case in which a high energy overvoltage is generated.

### DESCRIPTION OF THE PREFERRED EMBODIMENTS

A preferred embodiment of an input overvoltage protection circuit according to the present invention will be described in detail below with reference to the accompanying drawings.

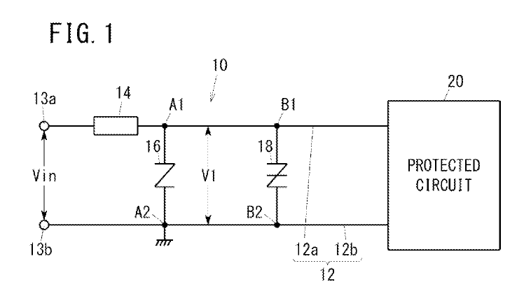

FIG. 1 is a diagram showing the circuit configuration of an input overvoltage protection circuit 10 according to an embodiment of the present invention. The input overvoltage protection circuit 10 serves to protect a protected circuit 20 from overvoltages (surges). The input overvoltage protection circuit 10 is equipped with voltage lines 12 (first wiring 12a, second wiring 12b), a fuse 14, a silicon surge absorber 16, and a bidirectional two-terminal thyristor (breakover type semiconductor surge absorber) 18.

In order to supply a voltage to the protected circuit 20, the voltage lines 12 are connected to the protected circuit 20. The voltage lines 12 include a first wiring 12a and a second wiring 12b. A potential, which is higher than a potential applied to an input terminal 13b of the second wiring 12b, is applied to an input terminal 13a of the first wiring 12a of the voltage lines 12. According to the present embodiment, the second wiring 12b is grounded (earth, ground). Accordingly, the potential of the second wiring 12b serves as a reference potential (0 V).

The fuse 14 is inserted into the first wiring 12a, and when a current greater than or equal to a predetermined value (standard) flows through the first wiring 12a, the current flowing through the first wiring 12a is interrupted. The silicon surge absorber (first surge absorber) 16 is connected in parallel with the protected circuit 20. One end of the silicon surge absorber 16 is connected between the protected circuit 20 and the fuse 14 in the first wiring 12a, whereas the other end thereof is connected to the second wiring 12b. In other words, a contact point A1 between the silicon surge absorber 16 and the first wiring 12a is positioned between the fuse 14 and the protected circuit 20. Moreover, a contact point between the silicon surge absorber 16 and the second wiring 12b defines another contact point A2.

The bidirectional two-terminal thyristor (second surge absorber) 18 is connected in parallel with the protected circuit 20 and the silicon surge absorber 16, respectively. The bidirectional two-terminal thyristor 18 is connected to the first wiring 12a and the second wiring 12b, at a location between the silicon surge absorber 16 and the protected circuit 20. More specifically, within the first wiring 12a and the second wiring 12b, one end and another end of the bidirectional two-terminal thyristor 18 are connected between the silicon surge absorber 16 and the protected circuit 20. In other words, a contact point B1 between the bidirectional two-terminal thyristor 18 and the first wiring 12a is positioned between the contact point A1 and the protected circuit 20, whereas a contact point B2 between the bidirectional two-terminal thyristor 18 and the second wiring 12b is positioned between the contact point A2 and the protected circuit 20.

According to the present embodiment, an input voltage applied to the input overvoltage protection circuit 10 (between the input terminals 13a and 13b) defines an input voltage Vin, and an applied voltage (output) applied by the silicon surge absorber 16 to the bidirectional two-terminal thyristor 18 defines an output voltage V1.

As discussed previously, the silicon surge absorber 16 has a characteristic to absorb voltages greater than or equal to a clamp voltage (clamping voltage) CV, and suppress a voltage applied to another subsequent stage circuit so as to remain at the clamp voltage (first voltage) CV. Further, energy absorbed by the silicon surge absorber 16 leads to heat being generated, and in accordance therewith, the temperature within the element of the silicon surge absorber 16 (hereinafter referred to as a junction temperature) rises. In other words, when a voltage is applied which is higher than the clamp voltage CV, the silicon surge absorber 16 suppresses the output voltage V1 to remain at the clamp voltage CV, and therefore, current flows inside the silicon surge absorber 16, whereby the junction temperature rises. When the junction temperature rises, the clamp voltage of the silicon surge absorber 16 increases. When the junction temperature rises and the junction temperature reaches a maximum junction temperature (maximum temperature), the silicon surge absorber 16 becomes damaged and short circuited. According to the present embodiment, the clamp voltage CV at a time when the junction temperature has become the maximum junction temperature is referred to as a maximum clamp voltage CVm. In addition, the clamp voltage CV at a time of a temperature (normal operating temperature) prior to the junction temperature rising is referred to as an initial clamp voltage CVi. Further, the bidirectional two-terminal thyristor 18 has a characteristic of becoming conductive when a voltage is applied thereto which is greater than or equal to a breakover voltage (second voltage) BV.

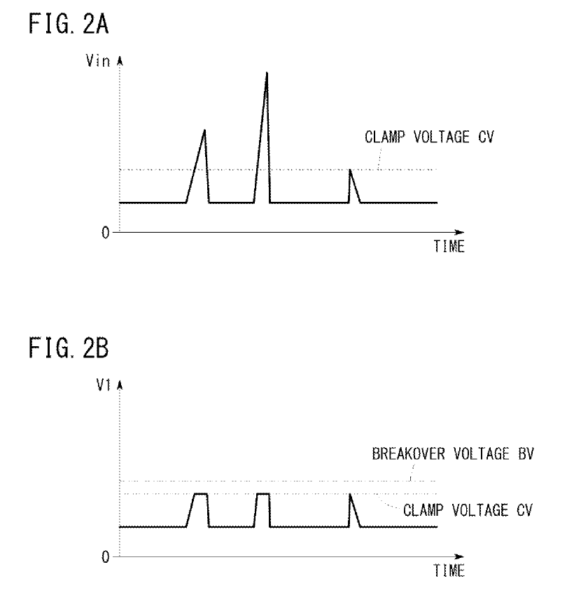

FIG. 2A is a graph showing an input voltage Vin waveform including therein momentarily generated low energy overvoltages, and FIG. 2B is a graph showing an output voltage V1 waveform of a silicon surge absorber 16 for a case in which the input voltage Vin shown in FIG. 2A is input thereto. As shown in FIG. 2A, within the input voltage Vin, there are included momentarily generated overvoltages (surges). The dashed line shown in FIGS. 2A and 2B represents the clamp voltage (clamping voltage) CV of the silicon surge absorber 16, and the one-dot-dashed line shown in FIG. 2B represents the breakover voltage BV of the bidirectional two-terminal thyristor 18. The breakover voltage BV is set to be higher than the initial clamp voltage CVi, and to be lower than the maximum clamp voltage CVm.

As shown in FIGS. 2A and 2B, even though overvoltages are generated momentarily within the input voltage Vin, due to the silicon surge absorber 16, the output voltage V1 is suppressed to remain at the clamp voltage CV. In other words, in the case that the input voltage Vin is of a voltage less than or equal to the clamp voltage CV, the silicon surge absorber 16 outputs the input voltage Vin as the output voltage V1, whereas if the input voltage Vin is higher than the clamp voltage CV, the silicon surge absorber 16 suppresses the output voltage V1 to remain at the clamp voltage CV. With such momentarily generated low energy overvoltages, since the junction temperature of the silicon surge absorber 16 does not rise very much, the clamp voltage CV at such times is of a voltage which is lower than the breakover voltage BV. Although it depends on the frequency at which the momentarily generated overvoltages are generated, in the case of such momentarily generated low energy overvoltages, the clamp voltage CV remains equal to the initial clamp voltage CVi or close to the initial clamp voltage CVi. Accordingly, in the case that an input voltage Vin having a momentarily generated low energy overvoltage therein is applied, since the overvoltage is absorbed by the silicon surge absorber 16, the bidirectional two-terminal thyristor 18 does not become conductive, and blowing of the fuse 14 does not occur.

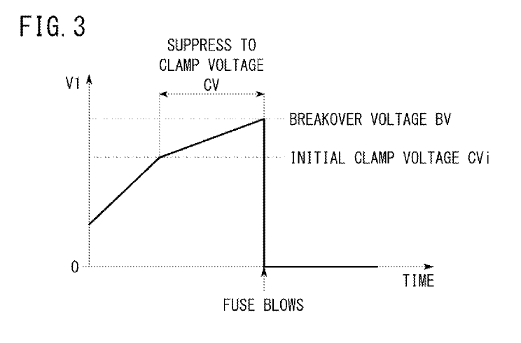

FIG. 3 is a graph showing an output voltage V1 waveform of the silicon surge absorber 16 for a case in which a high energy overvoltage is generated. When an input voltage Vin, which is higher than the initial clamp voltage CVi at a time of ordinary operating temperature, is input continuously or intermittently, or stated otherwise, when an input voltage Vin including a high energy overvoltage is input, the energy to be suppressed increases, and the junction temperature rises. Although the silicon surge absorber 16 suppresses the input voltage Vin that is greater than the clamp voltage CV to remain at the clamp voltage CV, and outputs the output voltage V1, the clamp voltage CV itself increases accompanying the rise in the junction temperature. Therefore, the suppressed output voltage V1 also rises. However, because the breakover voltage BV of the bidirectional two-terminal thyristor 18 is set to be higher than the initial clamp voltage CVi, and to be lower than the maximum clamp voltage CVm, the output voltage V1 arrives at the breakover voltage BV before reaching the maximum clamp voltage CVm. When the output voltage V1 arrives at the breakover voltage BV, since the bidirectional two-terminal thyristor 18 becomes conductive, a current greater than or equal to a predetermined value flows through the fuse 14, and the fuse 14 blows. Consequently, it is possible to prevent damage from occurring to the silicon surge absorber 16. More specifically, in the case that an input voltage Vin having a high energy overvoltage is applied, the silicon surge absorber 16 can be protected by the bidirectional two-terminal thyristor 18. Moreover, when the fuse 14 is blown, the output voltage V1 becomes zero.

As has been described above, the input overvoltage protection circuit 10 according to the present embodiment is equipped with the first wiring 12a and the second wiring 12b which are connected to the protected circuit 20 in order to supply a voltage thereto, the fuse 14 inserted in series in the first wiring 12a and which interrupts a current flowing through the first wiring 12a when a current greater than or equal to a predetermined value flows therethrough, the silicon surge absorber 16, one end of which is connected between the protected circuit 20 and the fuse 14 in the first wiring 12a, and the other end of which is connected to the second wiring 12b, and the bidirectional two-terminal thyristor 18 which is connected in parallel with the silicon surge absorber 16, and is connected to the first wiring 12a and to the second wiring 12b at a location between the silicon surge absorber 16 and the protected circuit 20.

Owing thereto, while suppressing costs and with a simple configuration, it is possible to protect the protected circuit 20 from overvoltages. More specifically, if a low energy overvoltage is momentarily generated, without blowing the fuse 14, the protected circuit 20 can still be protected from the low energy overvoltage by the silicon surge absorber 16. Further, in the event that a high energy overvoltage is applied, the fuse 14 is blown and the protected circuit 20 can be protected from the high energy overvoltage by the bidirectional two-terminal thyristor 18, and together therewith, it is possible to prevent the silicon surge absorber 16 from becoming damaged.

The breakover voltage BV of the bidirectional two-terminal thyristor 18 is set to be higher than the initial clamp voltage CVi before the junction temperature rises, and to be lower than the maximum clamp voltage CVm corresponding to a maximum temperature of the junction temperature (a temperature at which the silicon surge absorber 16 becomes damaged and short circuited). Consequently, even in the event that a high energy overvoltage is applied, prior to the silicon surge absorber 16 becoming damaged, since the bidirectional two-terminal thyristor 18 becomes conductive and the fuse 14 is blown, it is possible to prevent the silicon surge absorber 16 from becoming damaged, and costs can be reduced.

According to the present embodiment, although the fuse 14 is inserted in the first wiring 12a, the fuse 14 may be inserted in the second wiring 12b. Further, a potential, which is higher than a potential applied to the input terminal 13a of the first wiring 12a, may be applied to the input terminal 13b of the second wiring 12b. In this case, the first wiring 12a may be grounded. Furthermore, the second wiring 12b (or the first wiring 12a) on the side to be grounded may also be the ground. In this case, the end portions of the silicon surge absorber 16, the bidirectional two-terminal thyristor 18, and the protected circuit 20 on the side connected to the second wiring 12b (or the first wiring 12a) may also be grounded.

While the invention has been particularly shown and described with reference to a preferred embodiment, it will be understood that variations and modifications can be effected thereto by those skilled in the art without departing from the scope of the invention as defined by the appended claims.

What is claimed is:

1. An input overvoltage protection circuit comprising:
a first wiring and a second wiring which are connected to a protected circuit in order to supply a voltage thereto;
a fuse inserted in series in the first wiring and configured to interrupt a current flowing through the first wiring when a current greater than or equal to a predetermined value flows therethrough;
a first surge absorber, one end of which is connected between the protected circuit and the fuse in the first wiring, and another end of which is connected to the second wiring, and which is configured to suppress an applied voltage to a first voltage and output the first voltage in a case that the applied voltage is higher than the first voltage; and
a second surge absorber connected in parallel with the first surge absorber, and connected to the first wiring and to the second wiring at a location between the first surge absorber and the protected circuit, and which is configured to become conductive when a voltage greater than a second voltage is applied thereto.

2. The input overvoltage protection circuit according to claim 1, wherein:
the first voltage increases accompanying a rise in a temperature of an element of the first surge absorber; and
the second voltage is set to be higher than the first voltage before the temperature of the element rises, and is set to be lower than the first voltage corresponding to a maximum temperature of the element at which the first surge absorber is damaged and becomes conductive.

3. The input overvoltage protection circuit according to claim 1, wherein a potential which is higher than a potential applied to the second wiring is applied to the first wiring.

4. An input overvoltage protection circuit comprising:
a first wiring and a second wiring which are connected to a protected circuit in order to supply a voltage thereto;
a fuse inserted in series in the first wiring and configured to interrupt a current flowing through the first wiring when a current greater than or equal to a predetermined value flows therethrough;
a silicon surge absorber, one end of which is connected between the protected circuit and the fuse in the first wiring, and another end of which is connected to the second wiring; and
a bidirectional two-terminal thyristor connected in parallel with the silicon surge absorber, and connected to the first wiring and to the second wiring at a location between the silicon surge absorber and the protected circuit.

5. The input overvoltage protection circuit according to claim 4, wherein:
a clamp voltage of the silicon surge absorber increases accompanying a rise in a junction temperature of the silicon surge absorber; and
a breakover voltage of the bidirectional two-terminal thyristor is set to be higher than the clamp voltage before the junction temperature rises, and to be lower than the clamp voltage corresponding to a maximum temperature of the junction temperature.
